(19) United States
(12) Patent Application Publication
(10) Pub. No.: US 2024/0409562 A1
(43) Pub. Date: Dec. 12, 2024

(54) CHLORAMINE-FUNCTIONALIZED METAL-ORGANIC FRAMEWORKS FOR THE ELIMINATION OF BIOLOGICAL AND CHEMICAL THREATS

(71) Applicants: Northwestern University, Evanston, IL (US); The Hong Kong Polytechnic University, Kowloon (HK)

(72) Inventors: Omar K. Farha, Glenview, IL (US); John Xin, Kowloon (HK); Kaikai Ma, Evanston, IL (US); Timur Islamoglu, Evanston, IL (US); Yuk Ha Cheung, Kowloon (HK)

(21) Appl. No.: 18/694,896

(22) PCT Filed: Sep. 26, 2022
(86) PCT No.: PCT/US22/44689

§ 371 Date: Mar. 22, 2024

Related U.S. Application Data
(60) Provisional application No. 63/248,759, filed on Sep. 27, 2021.

(51) Int. Cl. C07F 7/00; A01N 55/02; A41D 13/11; A62B 18/02

(52) U.S. Cl. CPC C07F 7/00; A01N 55/02; A41D 13/1192; A62B 18/02

(57) ABSTRACT

Multifunctional and regenerable N-chlorine based biocidal and detoxifying metal-organic frameworks are provided. Chloramine functional groups on the organic linkers of the metal-organic frameworks act as chlorine carriers. Pathogens or harmful organic compounds that come into contact with the metal-organic frameworks in the presence of water are rendered inactive by reactions with the active chlorine. The metal-organic frameworks can be incorporated into textiles used to make protective wearable articles.

### CROSS-REFERENCE TO RELATED APPLICATIONS

The present application claims priority to U.S. provisional patent application No. 63/248,759 that was filed Sep. 27, 2021, the entire contents of which are incorporated herein by reference.

### REFERENCE TO GOVERNMENT RIGHTS

This invention was made with government support under W911NF-20-2-0136 awarded by the Army Research Office (ARO) and under HDTRA1-18-1-0003 awarded by the Defense Threat Reduction Agency (DTRA). The government has certain rights in the invention.

### BACKGROUND

Across health-care, chemical manufacturing, and military-based professional industries, protective clothing and masks represent a critical form of protection from biological and chemical threats encountered as a function of the workplace setting. Often, these textile-based materials serve to delay the penetration, rather than achieve the detoxification, of the selected threats. However, the need for the further development of active protective wear has resurfaced within recent years given the global pandemic caused by the SARS-CoV-2 virus in addition to the purposeful use of chemical warfare agents. Due to the exponential increase in the number of the infected people in the world, the World Health Organization (WHO) recommended the global use of face masks in 2020 to slow down the spread of SARS-CoV-2 through coughing or sneezing (i.e., virus-laden respiratory droplets). The global community looks for improved protective gear such as masks, gowns, and shields to protect themselves from SARS-CoV-2 infection. However, the demand for this equipment far outnumbers the supply of disposable protective gear, resulting in a global challenge to efficiently slow and ultimately stop the spread of the highly infectious virus, SARS-CoV-2. Unfortunately, once contaminated, these textile-based materials can still result in cross-infections given the virus's prolonged lifetime on surfaces. For example, it was found that the virus could be detected on wood and cloth within one day and on smooth surfaces glass and banknote for three days and on stainless steel and plastic for six days. (Doremalen, N. V. et al., Engl. J. Med. 2020, 382, 1564-1567.) More strikingly, a detectable level of the infectious virus was present on the outer layer of a surgical mask up to seven days. (Chin, A. et al., Lancet Microbe. 2020, 1, e10-e10.) In addition to the viruses, pathogenic bacteria also widely exist in various indoor and outdoor environments, such as in hospitals and elderly care homes.

The detection of such viruses and bacteria on surfaces days after contamination indicates that these surfaces, including protective suits and masks, can serve as contamination sources following exposure. Therefore, there is a need for biocidal personal protective equipment that not only blocks the biocidal threats, but also disintegrates them, thereby effectively slowing and stopping the spread of biohazardous threats. While there has been an effort towards designing biocidal textiles, many of these materials suffer from either tedious production process or poor efficacy. For example, some materials need complicated surface modification to render biocidal function, while some of them take a few hours to totally inactivate the target pathogen. (Simončič, B. et al., Text. Res. J. 2010, 80, 1721-1737: Purwar, R. et al., AATCC Rev. 2004, 4, 22-26; and Dastjerdi, R. et al., Colloids. and Surf. B. 2010, 79, 5-18.)

Metal-organic frameworks (MOFs), porous crystalline solids comprised of inorganic nodes and organic linkers, offer structural and chemical tunability amenable for a myriad of applications including toxic gas capture for air purification and the catalytic degradation of chemical warfare agents (CWAs). Moreover, MOFs have been incorporated into a range of wearable textile fibers to form MOF-based fibrous composites for targeted applications. For example, the detoxification of CWAs has been demonstrated using MOF/fiber composites which are paving the way for MOF-based protective suits and masks. Specially, a porphyrin-based MOF was coated onto textile and showed good catalytic selective oxidation of mustard gas simulant. (Lee, D. T. et al., Matter 2020, 2, 404-415.) MOFs have also been instrumental as light induced disinfectants for pathogens: however, accessing all-weather biocidal efficiency with these composite materials still remains a challenge. (Li, J. Et al., Nat. Commun. 2019, 10, 2177.) The integration of diverse functionalities, including those that offer biocidal and detoxifying activities, into active textiles against a wide spectrum of threats is still needed to protect the global community.

Biocidal active chlorine has been immobilized on textiles by grafting of N-halamine precursors, namely amine groups, onto fiber surfaces by chemical modification. (Si, Y. et al., ACS Biomater. Sci. Eng. 2017, 3, 854-862.) Cellulosic fibers containing abundant hydroxyl groups on the surface are amenable for such treatment, but inert synthetic fibers, such as polyethylene terapthalate, nylon, and polypropylene, are more challenging to modify with chlorine carriers. (Ren, X. et al., Carbohydr. Polym. 2009, 78, 220-226; Liang, J. et al., Biomaterials. 2006, 27, 2495-2501: Chen, Z. et al., Biomaterials. 2007, 28, 1597-1609; Ma, K. et al., J. Appl. Polym. Sci. 2014, 131, 1-6; Ren, X. et al., J. Biomed. Mater. Res. Part B, 2009, 89, 475-480; Lin, J. et al., J. Appl. Polym. Sci. 2002, 85, 177-182: Zhao, N. et al., Eur. Polym. J. 2011, 47, 1654-1663: Lin, J. et al., J. Appl. Polym. Sci. 2001, 81, 943-947; Ma, Y. et al., ACS Biomater. Sci. Eng. 2021, 7, 2329-2336.)

### SUMMARY

Multifunctional and regenerable N-chlorine based biocidal and detoxifying textiles that use chloramine-functionalized MOFs as chlorine carriers are provided. Also provided are methods of making the chloramine-functionalized MOFs, methods of forming fibers and fabrics that incorporate the chloramine-functionalized MOFs, and methods of using the MOFs and textiles incorporating the MOFs as biocidal and detoxifying agents.

The chloramine-functionalized MOFs include a MOF having metal nodes, organic linkers connecting the metal nodes, and chloramine functional groups on the organic linkers. The chloramine-functionalized MOFs may be synthesized by chlorinating the amine groups located on the organic linkers of an amine-functionalized MOF to convert the amine groups into N-chlorine structures. This method is highly scalable and may be carried out under benign conditions. The chloramine-functionalized MOFs can be incorporated into fibers and textiles by synthesizing amine-functionalized MOF in situ on a fiber or textile and subsequently converting the amine functionalities into chloramine functionalities via amine chlorination. Alternatively, the amine-functionalized-MOFs can be provided in the form of a crystalline powder that is applied onto fibers or textiles, either before or after the amine functional groups are chlorinated.

The chloramine-functionalized MOFs and fibers and textiles comprising the chloramine-functionalized MOFs can serve as protective agents against both biological and chemical threats. For example, the chloramine-functionalized MOFs exhibit rapid biocidal activity against both gram-negative bacteria (E. coli), gram-positive bacteria (S. aureus), and SARS-CoV-2 viruses, and rapidly degrade sulfur mustard (also known as mustard gas). Moreover, because the chloramine groups of the chloramine-functionalized MOFs are regenerable (e.g., using a simple chlorine bleaching), textiles that incorporate the chloramine-functionalized MOFs can be reused. As such, the chloramine-functionalized MOFs are useful in the production of protective wearable articles, including face masks (e.g., surgical masks), gowns, body-suits, and gloves.

One embodiment of a functionalized MOF includes: a MOF comprising metal nodes and organic linkers connecting the metal nodes; and chloramine functional groups on the organic linkers.

One embodiment of a textile includes: woven or non-woven fibers; and functionalized MOFs on the fibers, wherein the functionalized MOFs include: a MOF comprising metal nodes and organic linkers connecting the metal nodes; and chloramine functional groups on the organic linkers.

One embodiment of a method of deactivating a pathogen or organic molecule includes the step of exposing a chloramine-functionalized MOF of a type described herein to an environment comprising the pathogen or the organic molecule and water, whereby hypochlorite generated in the MOF reacts with and deactivates the pathogen or organic molecule.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A is a schematic diagram of a face mask.

FIG. 1B shows a schematic illustration of a chlorine loaded UiO-66-NH₂/polyethylene terephthalate (PET) composite and its regenerable biocidal and detoxifying function.

FIG. 2A, panels (i)-(iv), shows scanning electron microscope (SEM) images of (panel (i)) PET, (panel (ii)) UiO-66-NH₂/PET, (panel (iii)) UiO-66-NH₂/PET after treatment by NaClO, and (panel (iv)) after treatment by sodium dichloroisocyanurate (NaDCC). Scale bars are 10 μm. FIG. 2B shows powder X-ray diffraction (PXRD) patterns: FIG. 2C shows nitrogen sorption isotherms: FIG. 2D shows the chlorine loading of a UiO-66-NH₂/PET composite after different chlorination times. PET and MOF-808 (a zirconium MOF without amino functional groups) coated PET was also chlorinated as a control.

FIG. 3 shows a fragment of a UiO-66-NH—Cl crystal structure obtained from a single-crystal X-ray diffraction study. C, O, N and Cl atoms are represented by spheres: Zr coordination polyhedra are also shown. H atoms are omitted for clarity. Disorder of N—Cl in linker is removed for clarity.

FIGS. 4A-4B show the antimicrobial activities of a control composite (UiO-66NH₂/PET) and a UiO-66NH—Cl/PET composite against (FIG. 4A) E. coli and (FIG. 4B) S. aureus.

FIG. 5A shows viral growth of SARS-CoV-2 over time after exposure to a UiO-66NH—Cl/PET composite. FIG. 5B shows SARS-CoV-2 titers at time-point 48 h (PCR).

FIG. 6A shows the oxidation detoxification of 2-chloroethyl ethylsulfide (CEES) and mustard gas (HD) using a UiO-66-NH—Cl/PET composite. FIG. 6B shows the degradation kinetics of the CEES and HD with 3 equivalent active chlorines.

FIG. 7A shows an X-ray photoelectron spectroscopy (XPS) survey spectra comparison between the samples before and after chlorination reaction. FIG. 7B shows the high-resolution Cl 2p spectrum of UiO-66-NH—Cl/PET.

FIGS. 8A-8B show SEM images of (FIG. 8A) PET and (FIG. 8B) MOF-808/PET. Scale bares: 10 μm. FIG. 8C shows PXRD patterns of PET and MOF-808/PET. FIG. 8D shows N₂ sorption isotherm of MOF-808/PET.

FIG. 9A shows a PXRD pattern and FIG. 9B shows a nitrogen sorption isotherm of a scaled-up sample.

FIG. 10 shows a ¹HNMR spectrum of kinetic studies of selective oxidation reaction using a UiO-66-NH₂—Cl/PET composite. Only selective product, CEESO, was observed.

FIG. 11 shows a ¹³CNMR spectrum of kinetic studies of selective oxidation reaction using the UiO-66-NH₂—Cl/PET composite. Only selective product, CEESO, was observed.

FIGS. 12A-12B show (FIG. 12A) ¹HNMR and (FIG. 12B) ¹³CNMR spectra of an extract of a control reaction using a UiO-66-NH₂/PET composite. No oxidized product was observed.

FIG. 13 shows a proposed selective oxidation mechanism of CEES or HD. R is CH₃ or Cl atom for CEES and HD, respectively.

FIG. 14A shows the stability of chlorine in composite during storage. FIG. 14B shows the rechargeability of the UiO-66-NH—Cl/PET composite.

### DETAILED DESCRIPTION

Multifunctional and regenerable N-chlorine based biocidal and detoxifying MOFs and textiles incorporating the MOFs are provided. Also provided are methods of synthesizing the MOFs, methods of coating textile fibers and textiles with the MOFs, and methods of using the MOFs in biocidal and detoxifying applications.

MOFs are hybrid, crystalline, porous compounds made from metal-ligand networks that include metal nodes connected by coordination bonds to multitopic organic linkers. The metal nodes (also referred to as vertices) in the framework include metal ions or clusters. (By convention, carboxylates or other linker terminal groups or atoms are often represented as components of the nodes.) One or more of the organic linkers of the biocidal and detoxifying MOFs have one or more chloramine functional groups (—NH—Cl groups) bound thereto. The nitrogen atom of the chloramine functional groups is covalently bonded to a carbon atom of an organic linker, such as a ring carbon of an aromatic ring in the linker. Aromatic groups commonly found in the organic linkers of MOFs include pyrene groups, phenyl groups, and biphenyl groups.

The chloramine-functionalized MOFs can be made from a variety of MOFs having amine-functionalized linkers via chlorination of the amine functionalities. Amine-functionalized MOFs and methods for functionalizing the organic linkers of MOFs with amine groups are known. The amine-functionalized MOF UiO (UiO-66-NH₂) is one example of an amine-functionalized MOF that can be used in the synthesis of a chloramine-functionalized MOF (UiO-66-NH—Cl). UiO-66 MOFs are characterized by Zr₆O₄(OH)₄ octahedra that are 12-fold coordinated to adjacent octahedra via 1,4-benzene-dicarboxylate (BDC) organic linkers. Other types of amine-functionalized MOFs, including other MOFs comprising zirconium (Zr) nodes and/or BDC organic linkers can be used to form chloramine-functionalized MOFs. However, it should be understood that the amine-functionalized MOFs need not comprise Zr nodes and need not comprise BDC organic linkers. Other examples of suitable MOFs include, but are not limited to, MIL-53-NH₂, MIL-100-NH₂, MIL-125-NH₂, NU-1002-O—NH₂, NU-1002-m-NH₂, NU-912-NH₂, UiO-67-o-NH₂, and UiO-67-m-NH₂. (See, for example, Islamoglu. Timur, et al. “Presence versus proximity: the role of pendant amines in the catalytic hydrolysis of a nerve agent simulant.” Angewandte Chemie International Edition 57.7 (2018): 1949-1953; Tang. Jixin, et al. “Micropore environment regulation of zirconium MOFs for instantaneous hydrolysis of an organophosphorus chemical.” Cell Reports Physical Science 2.10 (2021): 100612; and Kim, Bomi, et al. “Adsorption of volatile organic compounds over MIL-125-NH₂.” Polyhedron 154 (2018): 343-349 for more details regarding the structures of these amine-functionalized MOFs.)

MOFs that are isostructural with the MOFs described above can also be functionalized with chloramine groups. Isostructural MOFs differ from one another with respect to the nature of the metal in the inorganic nodes. For example, isostructural hafnium MOFs, cerium MOFs, thorium MOFs, or bismuth MOFs can be used in place of their zirconium MOF counterparts.

The chloramine functionalized MOFs include channel-type MOFs and cage-type MOFs.

The amine-functionalized MOFs can be chlorinated by reacting the amine-functionalized MOFs with a chlorinating agent, such as a hypochlorite or dichloroisocyanurate salt or other N-chlorine bleach compounds, in aqueous solution. Optionally, if the MOF structure tends to degrade in basic solution, an acid, such as sulfuric acid, may be added to lower the pH to an acidic (<7) pH value. It is not necessary for every amine group on the linkers to be chlorinated. In various embodiments of the chloramine-functionalized MOFs, at least 20%, at least 40%, at least 60%, at least 80%, at least 90%, or 100% of the amine functional groups on the organic linkers are converted to chloramine groups. This includes chloramine-functionalized MOFs in which 10% to 100%, or 20% to 90% of the amine functional groups on the organic linkers are converted to chloramine groups.

The chloramine-functionalized MOFs can be incorporated into fibers and textiles made from fibers by coating the fibers or textiles with a solution of the chloramine-functionalized MOFs, coating the fibers or textiles with a solution of amine-functionalized MOFs and subsequently converting the amine groups into chloramine groups, or forming amine-functionalized MOFs in situ on the fibers or textiles and subsequently converting the amine groups into chloramine groups.

As used herein, the term textile refers to both woven and non-woven (e.g., felts), fiber-based cloths, where the fibers may be yarns, threads, and the like. The fibers may comprise or consist of only naturally occurring materials, such as cotton, or may comprise or consist of only non-naturally occurring (“synthetic”) materials, including, but not limited to, synthetic polymer fibers, such as polyethylene terephthalate, nylon, and polypropylene fibers.

Various MOF synthesis routes are known. For example, the MOFs can be synthesized by dissolving a metal salt containing the node metal (e.g., a zirconium salt if the MOF is a Zr-MOF), at least one organic linker-precursor, and an acid in a solvent to form a solution. The solution is then heated under conditions (temperatures and heating times) that induce the crystallization of the MOF from the metal salt and the organic linker-precursors. The organic linker-precursors are so-called because they are converted into the organic linkers of the MOF upon reaction with the metal salts. Solvothermal/hydrothermal synthesis is one example of a common MOF synthesis strategy. In solvothermal/hydrothermal synthesis, the metal salts and organic linker-precursors are mixed in solution and heated, typically to a temperature in the range from 100° C. to 250° C. However, other synthesis methods can be used.

The loading of chloramine-functionalized MOF on a fiber or textile that incorporates the chloramine-functionalized MOF (i.e., a chloramine-functionalized MOF-fiber composite or a chloramine-functionalized MOF-textile composite) depends on the particular pathogens or organic molecules to be decomposed and the extent of decomposition needed for a given situation. The chlorine loading of a chloramine-functionalized MOF-fiber composite or a chloramine-functionalized MOF-textile composite can be measured by an iodometric/thiosulfate titration method, as described in the Example. The chloramine-functionalized MOF-fiber composites and chloramine-functionalized MOF-textile composites may have chlorine loadings of at least 0.05 wt. %, at least 0.1 wt. %, or at least 1 wt. %. For example, the chlorine loading may be in the range from 0.05 wt. % to 20 wt. %, including in the range from 0.1 wt. % to 10 wt. %, and in the range from 0.2 wt. % to 2 wt. %. However, higher or lower ranges are also suitable.

The chloramine-functionalized MOFs can be used to deactivate a variety of harmful or undesired organic molecules and pathogens. Without intending to bound to a particular theory of any invention disclosed herein, the inventors propose that the activity of the chloramine-functionalized MOF can be attributed to the slow release of active chlorine through the pores of the MOF when the MOF is in contact with the organic molecules and/or pathogens in water, aqueous solution, or a water-containing environment, such as humid air. The active chlorine is generated when the water hydrolyzes the N—Cl bond to form HCIO. The porosity of the MOF is advantageous because it allows for the diffusion and slow release of the active chlorine as the chlorine on the surface is consumed and facilitates the diffusion of the organic molecules and/or pathogens to the active chlorine for a rapid reaction in the solid state.

The chloramine-functionalized MOFs can be used to deactivate any pathogen or organic molecule that is susceptible to deactivation by reaction with hypochlorite ions. As used herein, the term deactivation refers to the degradation of the harmful or disease-causing ability of the pathogen or organic molecule. For example, deactivation may entail degradation of the harmful or disease-causing ability of a pathogen or organic molecule via oxidation of the pathogen or organic molecule (“oxidation degradation”). Pathogens are microorganisms, such as bacteria or viruses, that can cause a disease or a harmful reaction in a living being, such as a human or other animal. In pathogens, such as bacteria, reaction with active chlorine may degrade enzymes, nucleic acids, and/or membrane lipids, for example. Specific, non-limiting examples of pathogens against which the chloramine-functionalized MOFs are effective include gram-negative (E. coli), gram-positive (S. aureus) bacteria, and the SARS-CoV-2 virus. Other pathogens that can be deactivated include pathogens that cause typhoid fever, dysentery, cholera and Legionnaires' disease. The hypochlorite also may be used to oxidize organic molecules that are used as chemical warfare (e.g., nerve) agents, such as sulfur mustard (HD), and other sulfur-containing compounds, including sulfur-containing organophosphate compounds, such as [2-(diisopropylamino)ethyl]-O-ethyl methylphosphonothioate (VX), and cyanide-containing compounds, such as tabun (GA).

The chloramine-functionalized MOFs act quickly, deactivating 90% or more of the pathogens or organic molecules present in the environment in a time period of 10 minutes or less. By way of illustration, at least 90%, at least 99%, at least 99.9%, at least 99.99%, or 100% of pathogens or organic molecules can be deactivated in an exposure time of 10 min or less, 5 minutes or less, or one minute or less. For example, exposure times in the range from 30 seconds to 10 minutes can achieve these high levels of deactivation. After use, the chloramine functional groups of the MOFs can be restored via rechlorination and the MOFs can be re-used in one or more additional detoxification cycles.

The chloramine-functionalized MOFs are effective at typical room and outdoor temperatures, including at or near room temperatures in the range from about 20° C. to about 30° C. and outdoor temperature in the range from about 1° C. to about 37° C. However, the chloramine-functionalized MOFs can also be used at higher and lower temperatures.

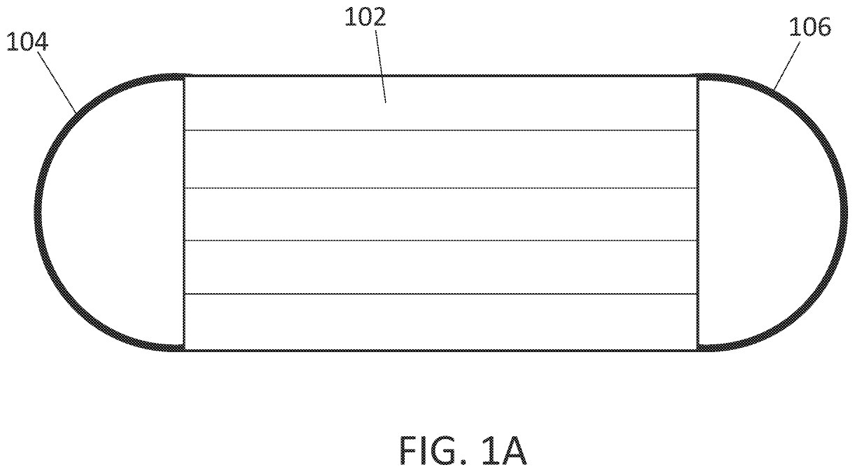

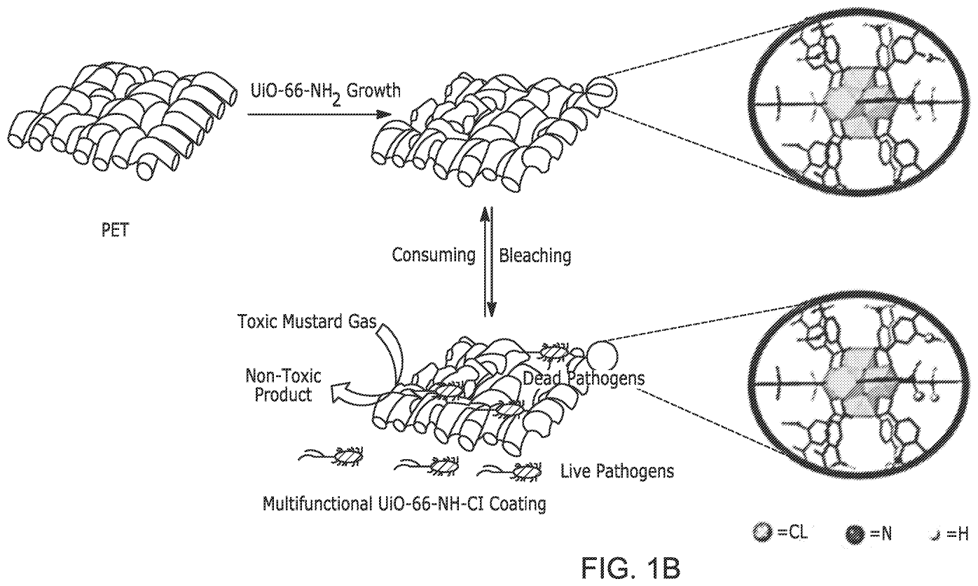

Textiles incorporating the chloramine-functionalized MOFs can be fashioned into an article of clothing or can be a part of a larger article of clothing. Protective face masks that incorporate the chloramine-functionalized MOFs can include a panel, typically, but not necessarily, a pleated or unpleated rectangular panel, designed to fit over a user's nose and mouth and two or more straps attached to the panel and designed to go around a user's ears and/or head to keep the panel in place. The panel of the face mask can be made of a textile incorporating chloramine-functionalized MOFs or the textile incorporating chloramine-functionalized MOFs can make up a portion of the panel. FIG. 1A is a schematic diagram of a face mask comprising a pleated panel 102 and two opposing ear straps 104, 106.

### Example

This Example illustrates the incorporation of an N-chlorine biocide into a textile via a porous UiO-66-NH₂, a stable zirconium-based MOF with —NH₂ functional groups in its organic ligands, as the regenerable carrier (FIG. 1B). The active chlorine atoms are bonded to the amine functionalized linker in the ordered framework to form chloramine groups by a simple immersion process in commercial bleaching solutions. Excitingly, the active chlorine loaded MOFs/fiber composite (UiO-66-NH—Cl/PET; PET=polyethylene terephthalate) was fast and potent for broad-spectrum inactivation of both Gram-positive and Gram-negative bacteria as well as the SARS-CoV-2 virus after a few minutes. The active chlorine in the MOF coating carrier demonstrated good stability and regenerability. Moreover, the chlorine loaded MOF/fiber composite also showed fast and selective oxidation degradation of highly-toxic mustard gas (HD) and its simulant 2-chloroethyl ethylsulfide (CEES) into nontoxic sulfoxide compounds (HDO and CEESO), respectively.

### Results and Discussion

### Material Synthesis

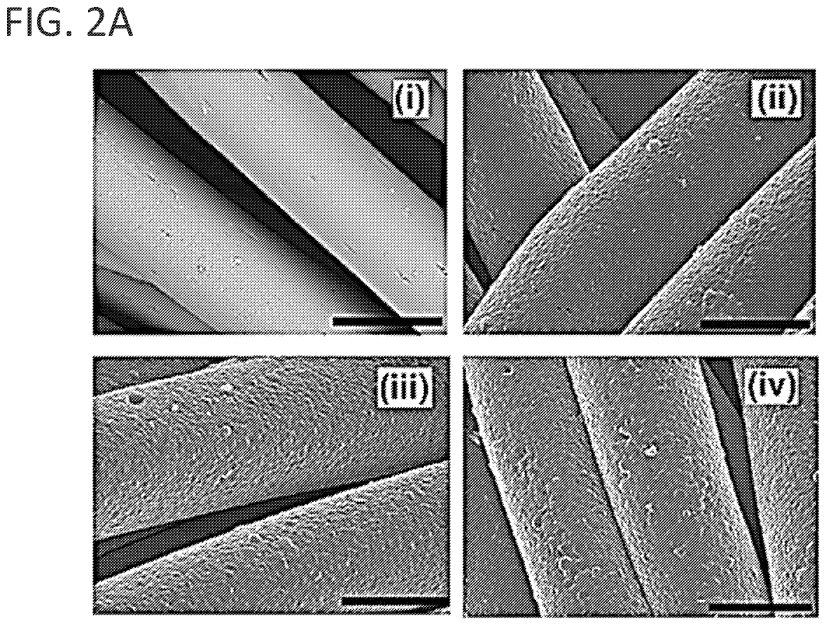

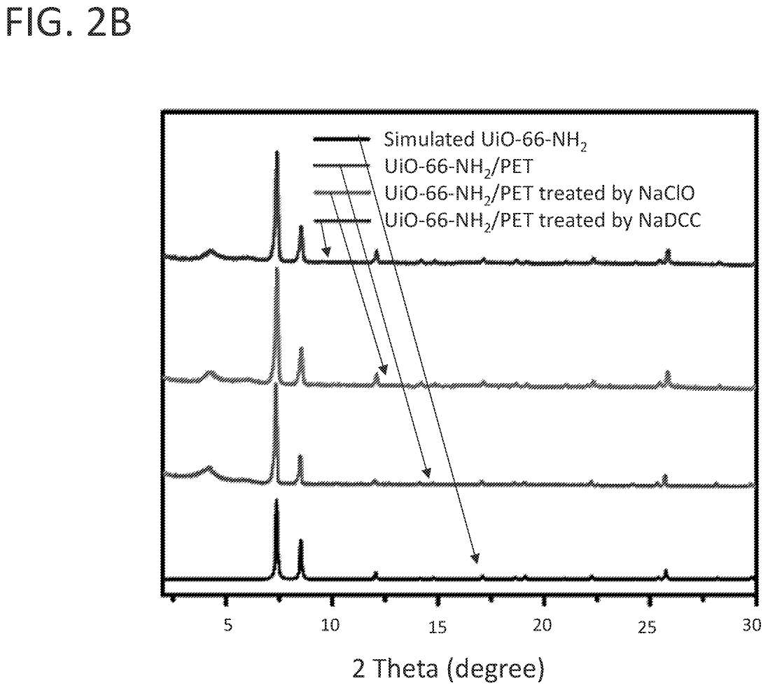

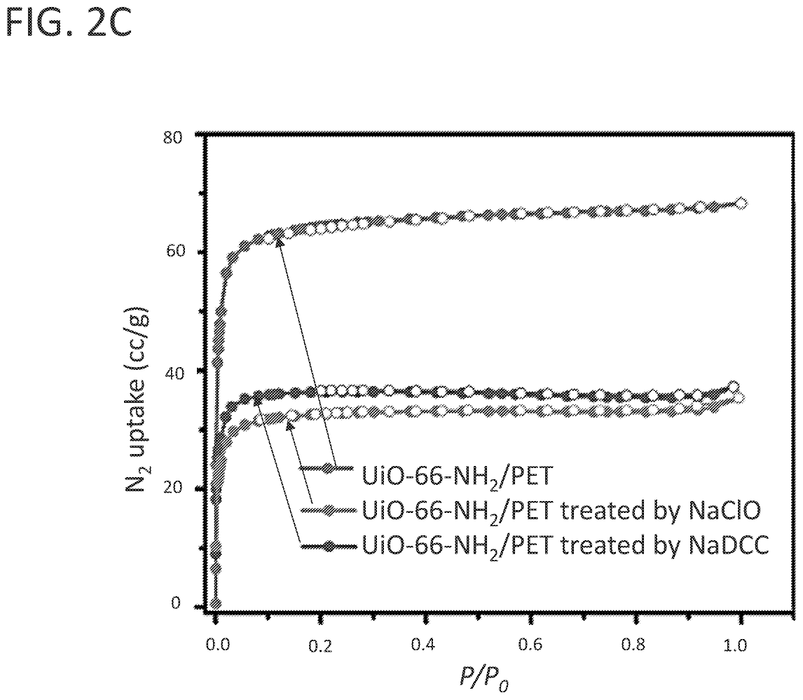

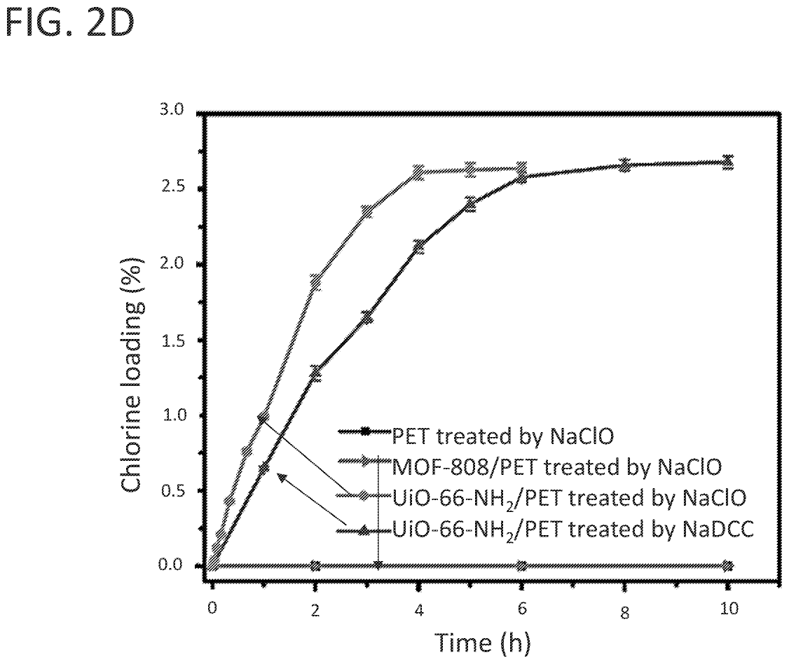

In this Example, a UiO-66-NH₂ coating was selected as a chlorine carrier because it possesses abundant amine groups for chlorine bonding and offers robust chemical stability within MOFs. Compared with formerly reported monolayer N-halamine coatings, the 3-dimensional MOF coatings supply more active sites. An intergrown UiO-66-NH₂ layer was coated onto PET cloth using a template-free aqueous synthesis method (FIG. 2A, panels (i)-(iv)). (Ma. K. et al., J. Am. Chem. Soc. 2019, 141, 15626-15633.) The crystallinity and porosity of the UiO-66-NH₂ coating were verified by PXRD and N₂ sorption studies (FIGS. 2B-2C), respectively. A mass loading of about 23 wt. % MOF on fiber was achieved based on inductively coupled plasma atomic emission spectroscopy (ICP-OES) analysis.

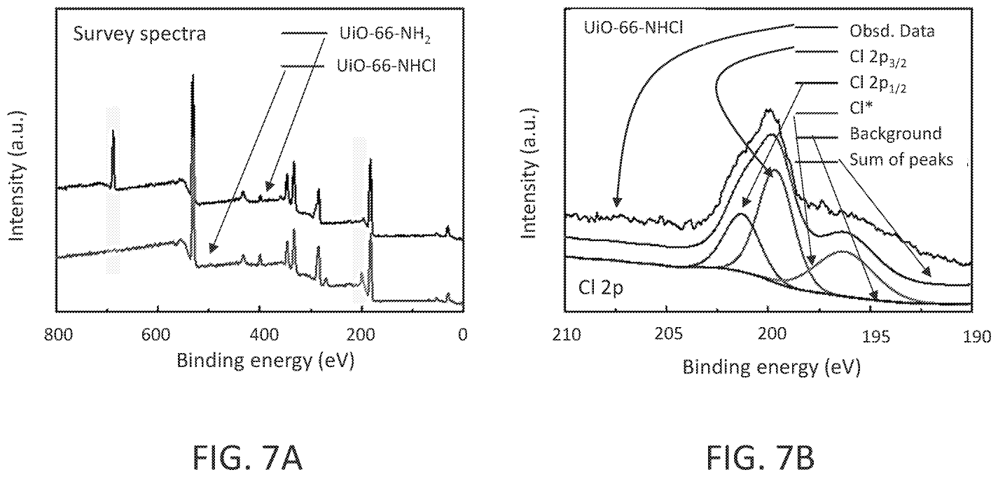

A 2% hypochlorite bleach solution (Clorox™, adjusting pH to 5) was used to chlorinate UiO-66-NH₂/PET, forming the resulting material referred to as UiO-66-NH—CI/PET. After the chlorination treatment, the MOF layer maintained its conformal coating morphology and crystallinity, as evidenced from the scanning electron microscopy (SEM) images and PXRD patterns, respectively (FIGS. 2A-2B). N₂ sorption isotherms showed that the UiO-66-NH—Cl/PET composite maintained about 50% of its original N₂ uptake (FIG. 2C). The drop in the nitrogen uptake was attributed to the mass gain and the pore volume occupied by the chlorine atoms. The presence of chlorine in the composite was confirmed through a series of experiments. First, a potassium iodine oxidation test was conducted which verified the existence of oxidizing chlorine in the MOF composite. (Liang, J. et al., 2006.) After mixing UiO-66-NH—Cl/PET with potassium iodine solution, the clear colorless solution turned brown immediately, indicating the presence of chlorine, while UiO-66-NH₂/PET without chlorination treatment did not cause any color change in the solution. The active chlorine loading of the composite was further quantified by iodometric/thiosulfate titration. (Si, Y. et al., 2017.) The titration indicated a chlorine loading of 2.6 wt. % after 6 h of chlorination treatment, indicating that 45% of the 2-aminobenzene-1,4-dicarboxylic acid (BDC-NH₂) linker within the MOF was converted to the N-chloramine group. The introduction of chlorine into the MOF coating was also verified by XPS (FIGS. 7A-7B). It is worth noting that adjusting the pH of the sodium hypochlorite solution (pH 5) is important to maintain the structure of the MOF coating, while the MOF coating partially degraded in basic (pH 11) chlorine bleaching solution without acidification. To simplify the chlorination step for practical application, a commercially available organic chlorine bleach agent, sodium dichloroisocyanurate (NaDCC, 1% in water), was also used without pH adjustment. (Clasen, T. et al., Int. J. Hyg. Environ. Health. 2006, 209, 173-181.) The final properties, including surface morphology, crystallinity, porosity, and chlorine loading, were comparable to that of sodium hypochlorite treatment, but the chlorine loading kinetics were slightly slower (FIG. 2D).

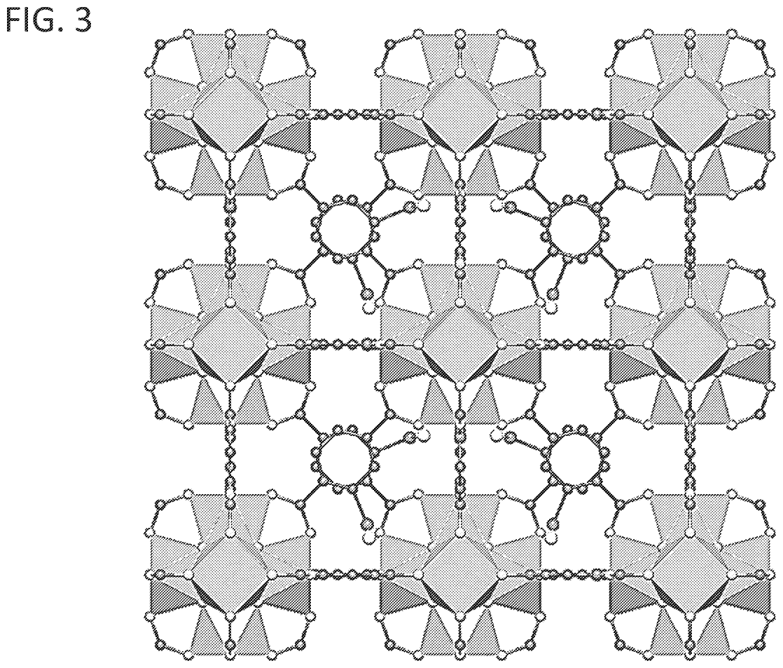

The crystallinity of MOFs allowed for locating the chlorine atoms within the framework, and to the best of the inventors' knowledge, this is the first heterogeneous system where the location of active chlorine is crystallographically resolved. Single-crystal X-ray diffraction (SCXRD) was used to characterize the active chlorine binding motif on the linker (FIG. 3 and Table 1). The existence of a Cl atom coordinating to a N atom with a N—Cl bond length of 1.772 Å was observed. The amount of Cl was calculated to be only one for each amino group with an occupancy of 0.5, matching well with the titration results.

TABLE 1
Crystal data and structure refinement for UiO-66-NH-Cl.

| Identification code | UiO-66-NH-Cl | |
|---|---|---|
| Empirical formula | C96Cl24N24O64Zr12 | |
| Formula weight | 4458.64 | |
| Temperature | 100(2) | K. |
| Wavelength | 1.54184 | A |
| Crystal system, space group | Cubic, Fm−3 m | |
| Unit cell dimensions | a = 20.8293(3) A | |
| | alpha = 90 deg. | |
| | b = 20.8293(3) A | |
| | beta = 90 deg. | |
| | c = 20.8293(3) A | |
| | gamma = 90 deg. | |
| Volume | 9036.9(3) | A\hat{ }3 |
| Z, Calculated density | 2, 1.639 | Mg/m\hat{ }3 |
| Absorption coefficient | 9.419 | mm\hat{ }−1 |

| | |
|---|---|
| F(000) | 4288 |
| Crystal size | 0.15 × 0.15× 0.15 mm |
| Theta range for data collection | 4.245 to 51.169 deg. |
| Limiting indices | −21 <= h <= 21, |
| | −17 <= k <= 20, |
| | −17 <= l <= 18 |
| Reflections collected/unique | 2598/296 [R(int) = 0.0189] |
| Completeness to theta = 51.169 | 99.7% |
| Refinement method | Full-matrix least-squares on F\hat{ }2 |
| Data/restraints/parameters | 296/25/39 |
| Goodness-of-fit on F\hat{ }2 | 1.269 |
| Final R indices [I > 2sigma(I)] | R1 = 0.0653, wR2 = 0.2430 |
| R indices (all data) | R1 = 0.0658, wR2 = 0.2436 |
| Extinction coefficient | n/a |
| Largest diff. peak and hole | 0.824 and −1.042 e.A\hat{ }−3 |

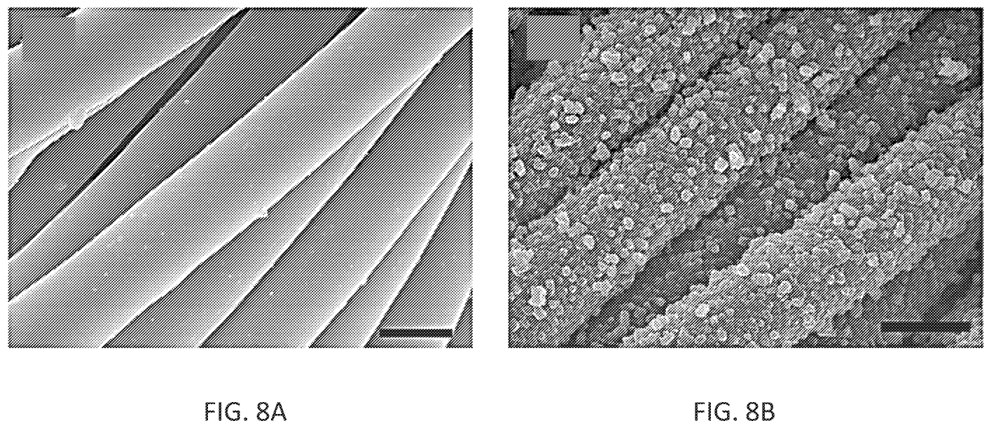

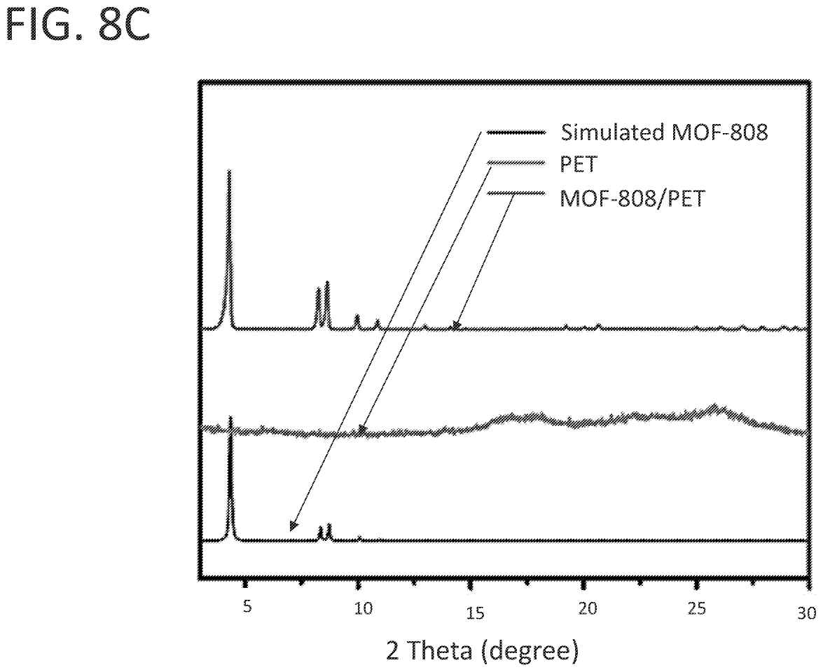

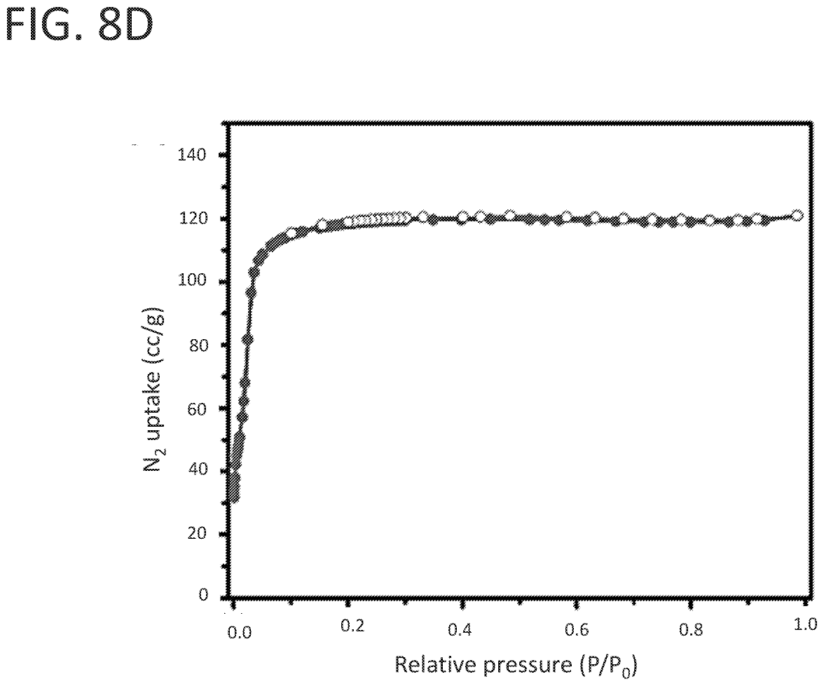

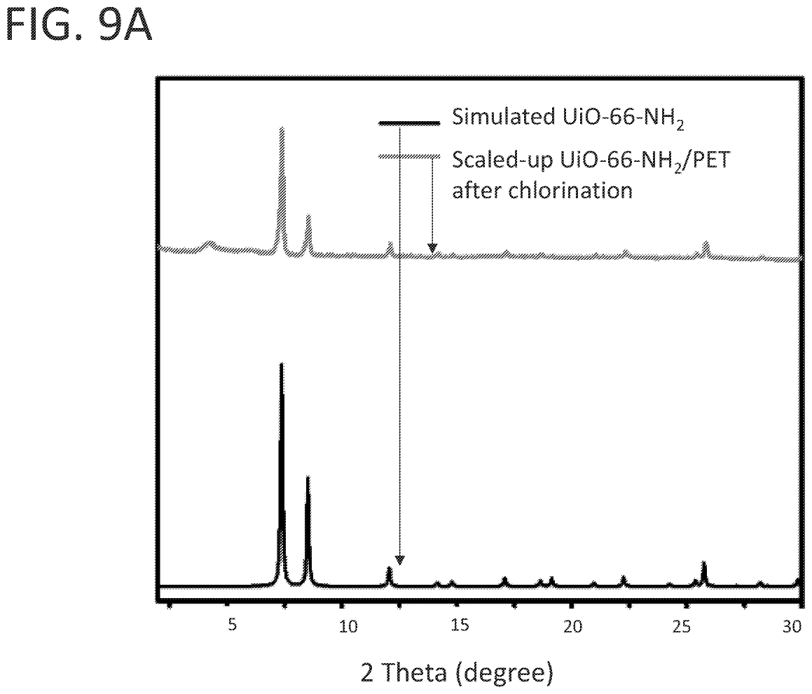

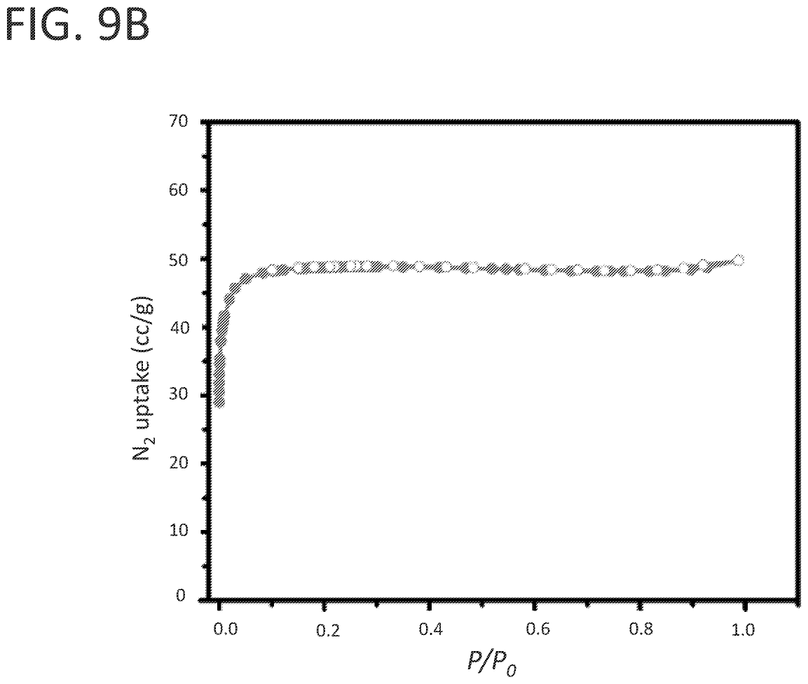

As a control experiment, the chlorination treatment was also applied to the bare PET fiber as well as to another zirconium-based MOF coated PET. Specifically, MOF-808 was used, a zirconium-based MOF that contains a similar Zr₆ node found in UiO-66-NH₂ but benzene tricarboxylic acid as the linker which lacks the amino group. In each of these controls, no active chlorine loading was detected, indicating the amino groups serve as the anchoring points for active chlorine (FIGS. 8A-8D). The method used here can be easily scaled up as there is no special equipment needed apart from conventional processing equipment. A large piece of UiO-66-NH—Cl/PET composite (20 cm×20 cm) was prepared in a scaled-up synthesis (FIGS. 9A-9B) and achieved an active chlorine loading of 1.75 wt. % after 2 h treatment, similar to that from the small batch (1.88 wt. %). Additionally, this method relies on an aqueous medium for the materials syntheses to reduce the negative environmental impact.

### Antimicrobial Activity

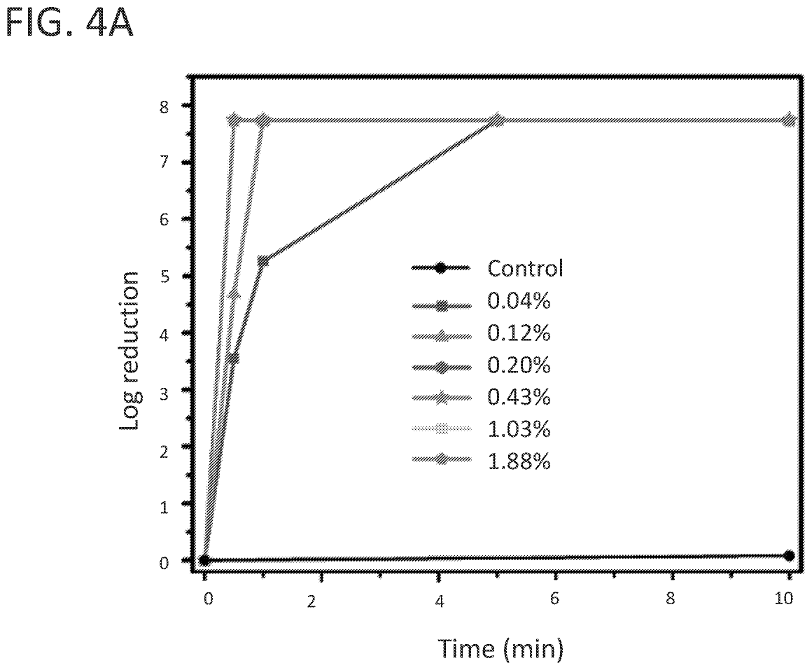

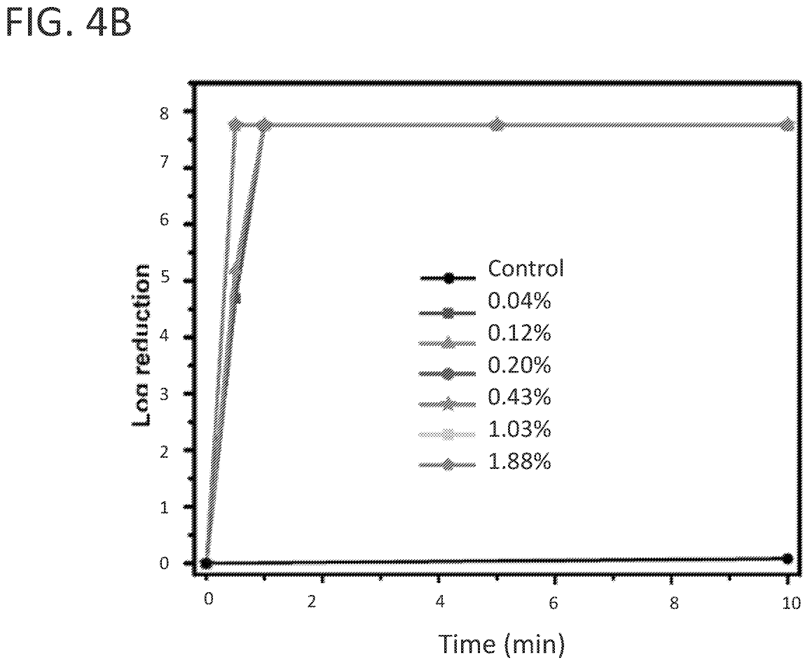

The antimicrobial activities of UiO-66-NH—Cl/PET composite with Gram-negative Escherichia coli (E. coli) and Gram-positive Staphylococcus aureus (S. aureus) bacteria were next investigated according to a modified American Association of Textile Chemists and Colorists (AATCC) Test Method 100-2004. (Liang, J. et al., 2006.) The control (UiO-66-NH₂/PET) and UiO-66-NH—Cl/PET samples with a size of 5 cm×5 cm were loaded with 100 μl of 1× 107 colony-forming units (CFU) of a bacterial suspension for a certain contact time, after which the bacteria were removed from the textile with a sodium thiosulphate solution to quench any active chlorine. The antibacterial efficacy was determined based on the viable microbial amount by agar plate counting. Neither the pristine PET nor the unchlorinated UiO-66-NH₂/PET control samples exhibited any biocidal effects; however, the UiO-66-NH—Cl/PET composite showed potent antimicrobial properties, providing a total sterilization of 107-108 CFU/mL of E. coli and S. aureus in less than 5 min (FIGS. 4A-4B). The UiO-66-NH—Cl/PET composite provided stronger antimicrobial performance against Gram-positive S. aureus than Gram-negative E. coli. For example, with a 0.04% chlorine loading and after 0.5 min of contact, the chlorinated composite provided a 3.6 log (99.97%) reduction of E. coli, but it offered a 4.7 log (99.998%) reduction of S. aureus. When the contact time was extended to 1 min, UiO-66-NH—Cl/PET (0.04% chlorine) exhibited a 5 log reduction (99.999%) of E. coli, and it demonstrated a 7.8 log (100%) reduction of the S. aureus tested. The biocidal activity of the N—Cl modified Zr-MOF coating is from the slow release of active chlorine through the pores of the MOF when it is in contact with the pathogens. The active chlorine is generated when the water from the surrounding hydrolyzes the N—Cl to form HClO. (Ma, K. et al., 2014.) The porosity of the MOF allows for the diffusion and slow release of the active chlorine as the chlorine on the surface is consumed. The difference in antibacterial efficiency against Gram-negative and Gram-positive strains is also reported in other N-halamine biocides, which could be attributed to the cell wall structural difference between these two types of bacterial phyla. (Chen, Z. et al., 2007.) A major structural difference between Gram-negative bacteria and Gram-positive bacteria is that the former bacteria possess a protective cell wall with an outer lipopolysaccharide membrane. This lipopolysaccharide membrane acts as a barrier layer, reducing the antimicrobial agent penetration into the cell. Therefore, the UiO-66-NH—Cl/PET composite required a longer contact time for the total sterilization of E. coli than S. aureus. As a general trend, samples with a higher chlorine loading displayed a higher antimicrobial potency. For example, the composite sample with a 0.12% chlorine loading showed a 4.7 log (99.998%) and 5.2 log (99.999%) reduction against E. coli than S. aureus after 0.5 min, respectively, and a 7.7 log (100%) and 7.8 log (100%) reduction after 1 min contact. The composite with 0.2% or more chlorine loading showed a total inactivation of two bacterial strains after 0.5 min. Representative agar plates illustrated the total deactivation of the two strains by the chlorinated samples in sharp contrast to the UiO-66-NH₂/PET control samples. Moreover, morphological changes in the bacteria after treatment were observed by SEM. S. aureus and E. coli retained intact spherical and Corynebacterium morphologies after exposure to the control sample (UiO-66NH₂/PET), while the UiO-66-NH—Cl/PET treated bacteria showed obvious cellular deformation and membrane collapse.

### Antiviral Activity

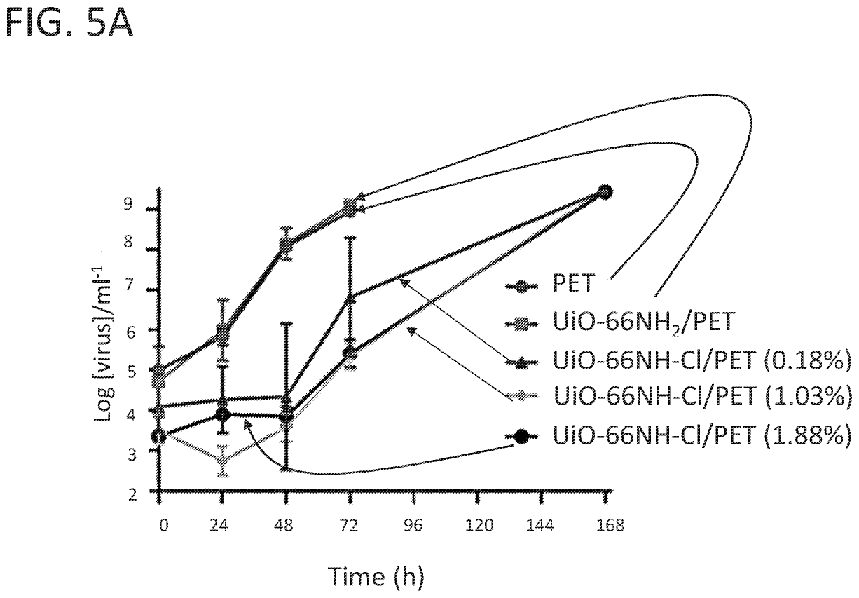

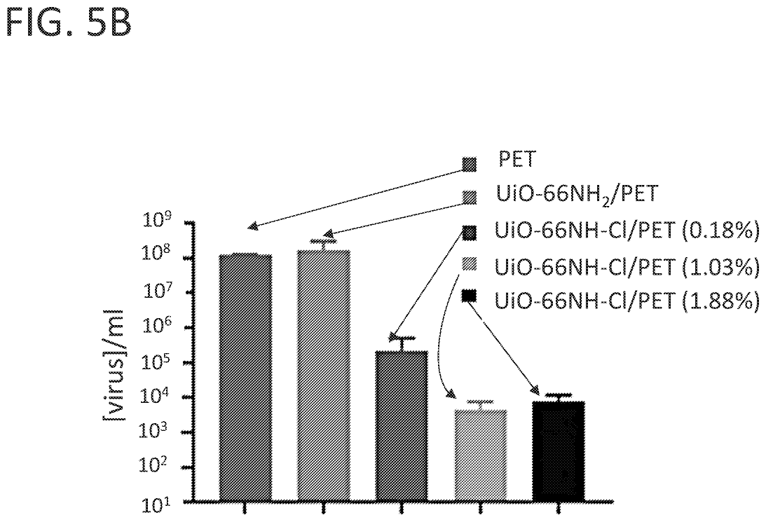

The biocidal activity of the material was further probed by measuring its effect on SARS-CoV-2, the pathogenic microorganism responsible for the global COVID-19 pandemic. Briefly, a UiO-66-NH—Cl/PET sample was contacted with a titer of 108 SARS-CoV-2 virus particles/ml for 15 min. Next, the virus particles were extracted from the textile with an aqueous sodium thiosulphate solution to quench any co-extracted active chlorine and then incubated with Vero host cells. Over the following days, the virus titer was determined using reverse transcription polymerase chain reaction (RT-qPCR) and photos were taken from the Vero cells to monitor their integrity. UiO-66-NH—Cl/PET loaded with 0.18%. 1.03%, and 1.88% of active chlorine was exposed to SARS-CoV-2. Both the bare PET and the UiO-66-NH₂/PET composite were used as controls. FIG. 5A shows the virus titers determined by RT-qPCR for 7 consecutive days after textile exposure to SARS-CoV-2. Both the unmodified cloth and the inactive MOF/PET composite immediately showed increasing virus titers and reached 109 mL-1 within 3 days, indicating rapid infection and virus replication. In contrast, the chlorinated textiles showed a significant delay in virus growth for 48 h, after which the virus titer started to increase. The corresponding Vero cell photographic images confirmed the infection of the Vero cells with the control (UiO-66-NH₂/PET) as a clear cytopathic effect evident by the presence of cell debris and cell rounding as a result of infection and subsequent cell death, while the chlorinated MOF (UiO-66-NH—Cl/PET) showed a confluent, densely populated monolayer of live cells.

These RT-qPCR results indicated that a log 3-5 reduction in virus titer was observed after 48 hours in the active cloth samples as compared to the controls (FIG. 5B), which is in line with previously reported sensitivity of Coronaviruses to oxidative media. (Sattar, S. et al., Epidemiol. Infect. 1989, 102, 493-505: Pagat, A. et al., Appl. Biosaf. 2007, 12, 100-108: Lai, M. et al., Clin. Infect. Dis. 2005, 41, 67-71: Goyal, S. et al., J. Hosp. Infect. 2014, 86, 255-259; Omidbakhsh, N. et al., Am. J. Infect. Control. 2006, 34, 251-257.) A slight increase in sterilization occurred with the 1.0% active chlorine sample as compared to the 0.2% active chlorine sample. However, a further increase in activity in the 1.8% active chlorine sample was not observed in contrast to the 1.0% sample.

### Degradation of Mustard Gas and its Simulant

Recently, the catalytic photooxidation of 2-chloroethyl ethyl sulfide (CEES), a less toxic chemical simulant of HD, as well as HD itself have been explored through the generation of singlet oxygen from various photosensitizers. (Liu, Y. et al., J. Mater. Chem. A. 2016, 4, 13809-13813: Liu, Y. et al., ACS Nano. 2015, 9, 12358-12364.) However, these studies required a light-emitting diode (LED) and organic solvent (i.e., methanol). This introduces a challenge to overcome before its implementation in practical applications since achieving the selective oxidation in the solid state and in the absence of light is required. Given that haloamines are effective oxidants for oxidation of sulfur containing compounds, the efficiency of UiO-66-NH—Cl/PET for oxidation of CEES in a solvent and light-free environment was investigated.

The ordered porous pathways in MOF coatings are hypothesized to facilitate the diffusion of the substrate to the active chlorine for a rapid reaction in the solid state. CEES (0.33 mol % relative to loaded chlorine) was added to the UiO-66-NH—Cl/PET composite, and after a designated contact time, the chlorine was quenched by sodium thiosulfate to stop the reaction. The extract was then analyzed by nuclear magnetic resonance (NMR) spectroscopy.

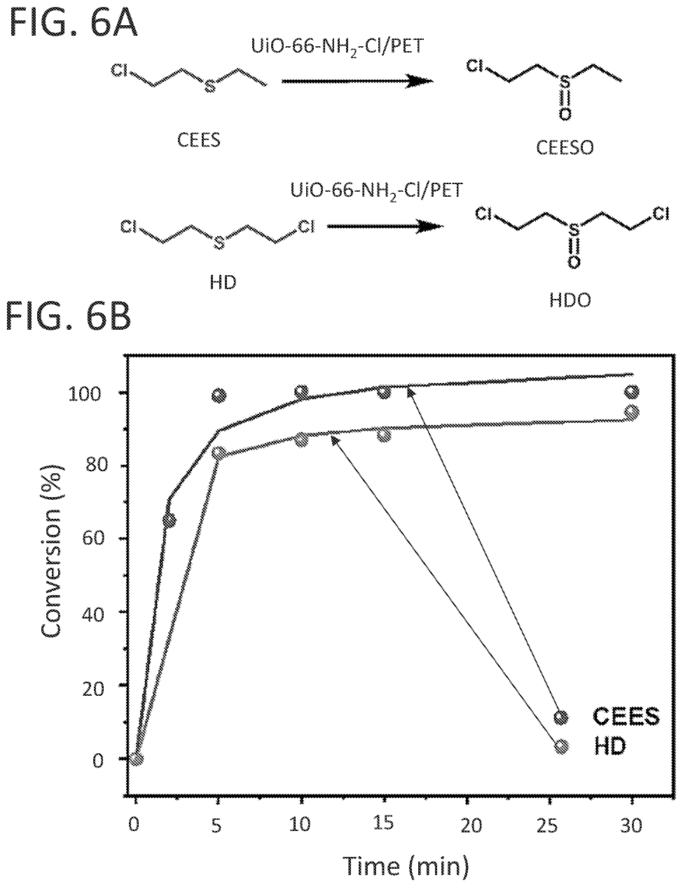

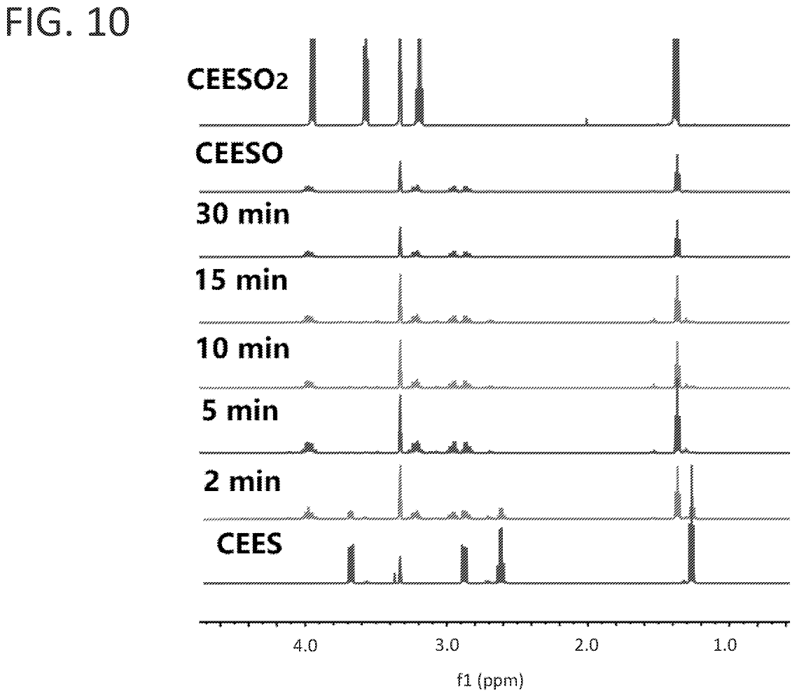

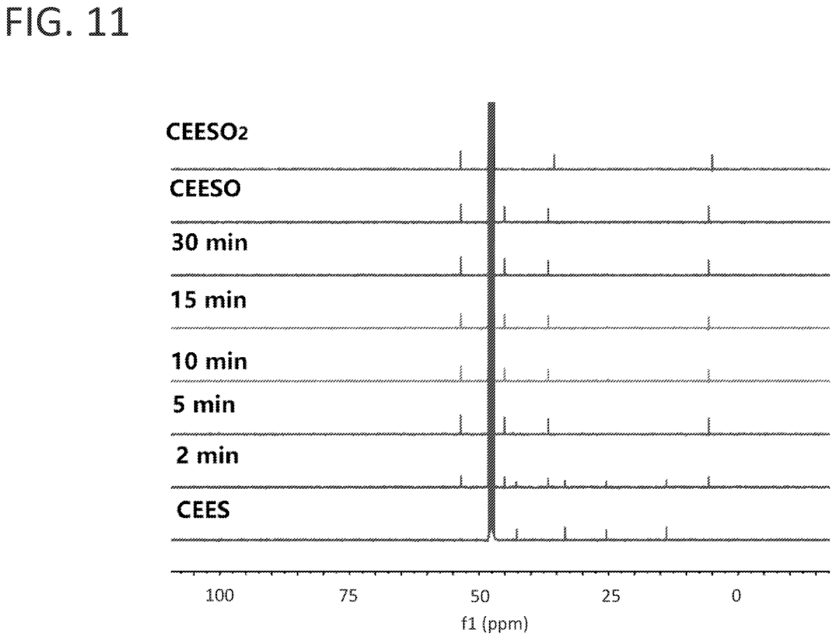

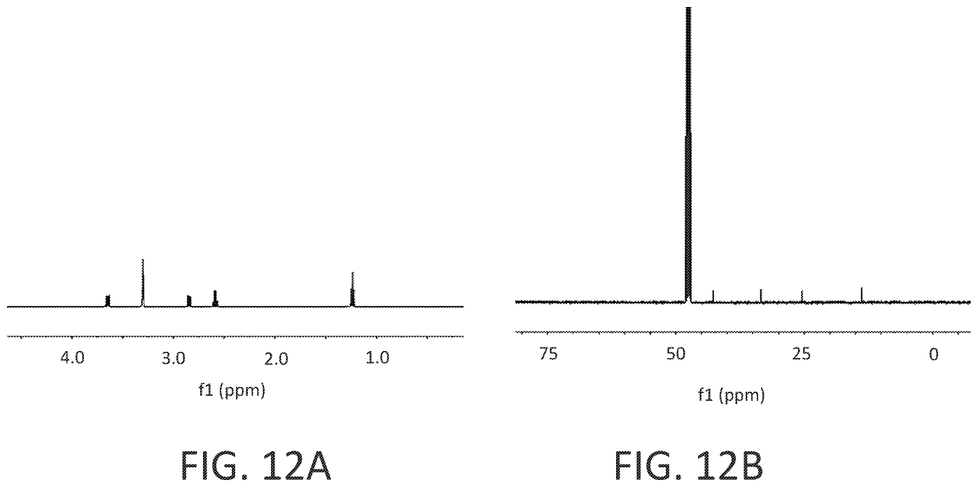

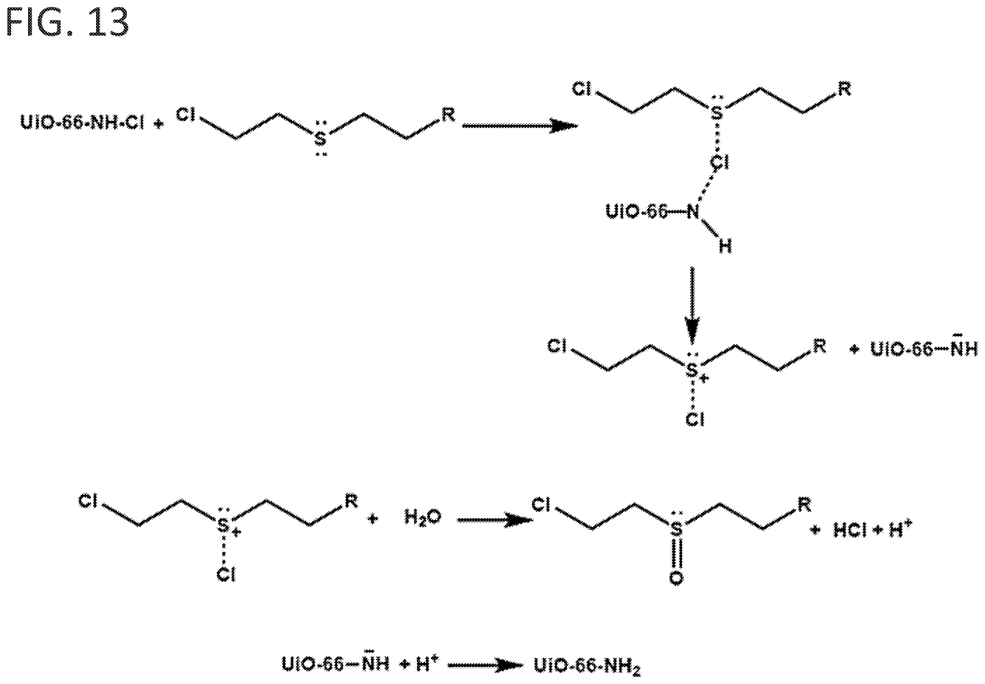

The NMR results demonstrated the selective oxidation of CEES to nontoxic sulfoxide product 2-chloroethyl ethyl sulfoxide (CEESO) (FIG. 6A and FIGS. 10-11) by the UiO-66-NH—Cl/PET composite without the generation of the highly toxic overoxidized product, 2-chloroethyl ethyl sulfone (CEESO2). With 3 equivalents of active chlorine, 80% of the CEES was selectively oxidized into CEESO after 2 min, and 99% conversion was obtained after 5 min (FIG. 6A and FIGS. 12-13). However, the unchlorinated UiO-66-NH₂/PET exhibited negligible CEES oxidation after 30 min (FIG. 12), which indicated that the active chlorine loaded in the MOF coating selectively oxidized the CEES. A possible reaction mechanism was proposed (FIG. 13). (Akdag, A. et al., Phosphorus Sulfur. 2007, 182, 1525-1533.) The lone pairs on the sulfur abstract the chlorine in UiO-66-NH—Cl to form a chlorosulfonium ion intermediate, which then reacts with water to generate sulfoxide and HCl as byproduct. (Akdag, A. et al., 2007.) Given the extraordinary selectivity and activity of this method using UiO-66-NH—Cl/PET, the composite was tested for the detoxification of sulfur mustard (HD). After 5 min, the chlorinated MOF composite converted 80% of HD to the nontoxic sulfoxide product (HDO). The half-life for HD oxidation degradation was observed to be ˜3 min when using 3 equivalents of immobilized chlorine in the MOF coating (FIG. 6B). The fast solid-state detoxifying kinetics represent an important step in developing protective gear active under ambient conditions against sulfur-containing chemical warfare agents.

### Chlorine Stability and Regenerability

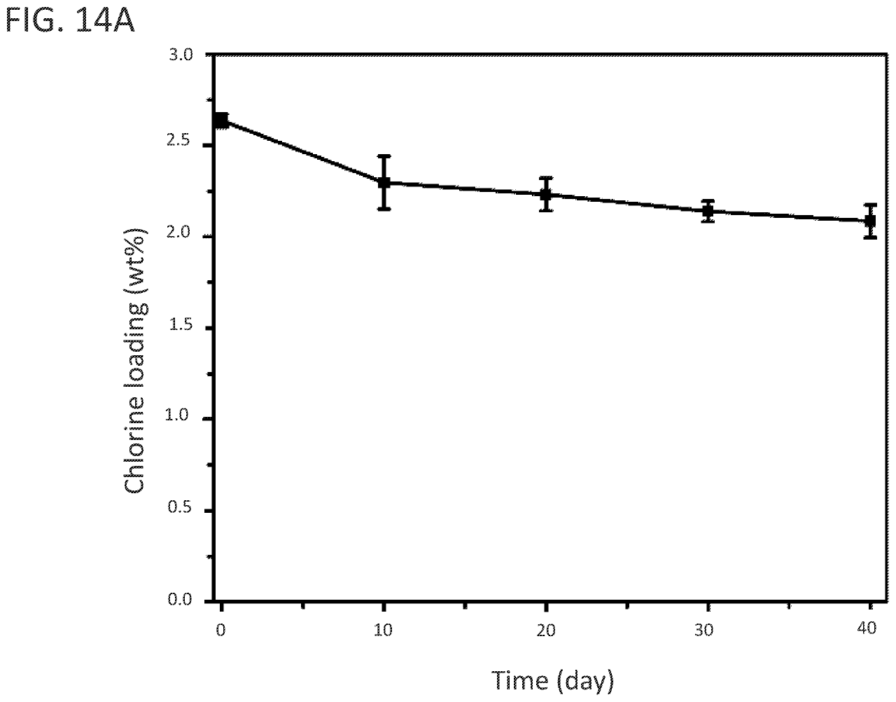

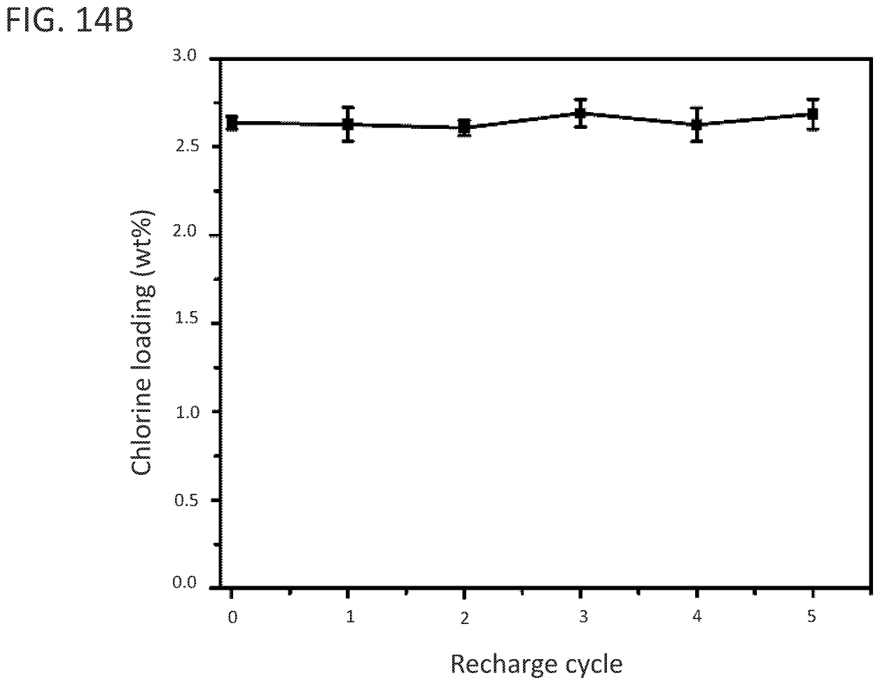

As the release of chlorine during storage could reduce the biocidal efficacy, the stability and regenerability of the UiO-66NH—Cl/PET composite were investigated. After storage for 40 days under ambient conditions in a sealed vial, the UiO-66-NH—Cl/PET composite maintained 77% of its original chlorine loading (chlorine loading: 2.0%, FIGS. 14A-14B). The antibacterial test demonstrated a total sterilization of two bacteria strains after 0.5 min contact. To simulate the possible leach of active chlorine from composite on human skin, a quantitative evaluation was conducted via iodometric/thiosulfate method. (Ma, K. et al., J. Appl. Polym. Sci. 2014.) After immersing the 1 g composite with 1.88% active chlorine loading in 20 mL saline water (0.9% NaCl in water, typical salt concentration in human sweat) for 48 hours, the released chlorine concentration was found to be only 3 ppm, which is below the maximum contaminant level goal (4 ppm) in drinking water suggested by United States Environmental Protection Agency. The slow release of active chlorine implies the practical application of N-chloride MOF coating. To evaluate the cyclability of the composite system, the active chlorine was quenched by a 0.1% sodium thiosulfate solution and then rechlorinated with a sodium hypochlorite solution. After 5 quenching and rechlorination cycles, the same chlorine loading on the MOF composite was achieved, indicating excellent regenerability of the MOF/fiber composite as well as overall stability of the MOF coating layer (FIGS. 14A-14B). The regenerability of the MOF coating afforded good reusability of the protective cloth, which is critical in addressing the growing waste caused by disposable healthcare textiles.

### Experimental Section

### Materials

ZrOCl₂·8H₂O (98%), benzene-1,3,5-tricarboxylic acid (BTCA, 98%), 2-aminobenzene-1,4-dicarboxylic acid (BDC-NH₂, 99%), Tween 20, Sodium dichloroisocyanurate (NaDCC), and trifluoroacetic acid (TFA, 99%) were purchased from Sigma-Aldrich. Deionized water (DI) was used as the water source throughout the experiments. Bleaching solution was purchased from Clorox. Polyethylene Terephthalate (PET) fabric was provided by China Dyeing holdings Ltd., Hong Kong to J.H.X. Before using, PET fabric samples were scoured in a 3% NaOH water solution at 90° C. for 20 min to remove impurities, and the NaOH residue on fabric was removed by thorough water washing. Other chemicals were purchased from Fisher Chemical. The composites for CEES and HD oxidation were synthesized in Northwestern University.

### Instrumentation

Powder X-ray diffraction (PXRD) patterns of fiber substrates and MOFs/fiber composite were recorded at room temperature on a STOE-STADIMP powder diffractometer equipped with an asymmetric curved Germanium monochromator (CuKα1 radiation, λ=1.54056 Å) at IMSERC (Integrated Molecular Structure Education and Research Center) of Northwestern University. N₂ adsorption and desorption isotherms of all materials were tested on a Micromeritics Tristar instrument at 77 K. Morphological images of all bacterial samples were taken with a Vega 3 Tescan scanning electron microscope. Scanning electron micrograph (SEM) images of all fiber materials were taken with a Hitachi SU8030 scanning electron microscope. Before SEM observation, all samples were coated with OsO₄ to ˜9 nm thickness in a Denton Desk III TSC Sputter Coater. Inductively coupled plasma-Optical emission spectroscopy (ICP-OES) was tested using an iCAP™ 7600 ICP-OES Analyzer (Thermo Scientific™) over the 166-847 nm spectral range. NMR spectra were collected on 400 MHz Agilent DD MR-400 at IMSERC (Integrated Molecular Structure Education and Research Center) of Northwestern University. Single-crystal X-ray structure analyses were carried out using a Bruker Kappa APEX II CCD detector equipped with a Cu Kα (λ=1.54178 Å) microsource with MX optics. The single crystals were mounted on MicroMesh (MiTeGen) with paratone oil at 200 K under a nitrogen cryostream. The structures were determined by intrinsic phasing (SHELXT 2014/5) 1 and refined by fullmatrix least-squares refinement on F2 (SHELXL-2017/1) 2 using the Olex23 software package. Refinement results are summarized in Table 1 and Table 2. Crystallographic data in CIF format have been deposited in the Cambridge Crystallographic Data Centre (CCDC) under deposition numbers CCDC-2100896 (UiO-66-NH—Cl). The data can be obtained free of charge via www.ccdc.cam.ac.uk/data_request/cif (or from the Cambridge Crystallographic Data Centre, 12 Union Road, Cambridge CB2 1EZ, U.K.).

TABLE 2
Bond lengths [A] and angles
[deg] for UiO-66-NH-Cl.

| Zr(1)—O(2) | 2.151 | (8) |
|---|---|---|
| Zr(1)—O(2)#1 | 2.151 | (8) |
| Zr(1)—O(2)#2 | 2.151 | (8) |
| Zr(1)—O(2)#3 | 2.151 | (8) |
| Zr(1)—O(1) | 2.209 | (9) |
| Zr(1)—O(1)#4 | 2.209 | (9) |
| Zr(1)—O(1)#5 | 2.209 | (9) |
| Zr(1)—O(1)#3 | 2.209 | (9) |
| Zr(1)—Zr(1)#6 | 3.509 | (3) |
| Zr(1)—Zr(1)#7 | 3.509 | (3) |
| Zr(1)—Zr(1)#8 | 3.509 | (3) |
| Zr(1)—Zr(1)#9 | 3.509 | (3) |
| O(1)—C(3) | 1.364 | (16) |
| C(2)—C(1)#10 | 1.36 | (3) |
| C(2)—C(1) | 1.36 | (3) |
| C(2)—C(3) | 1.48 | (3) |
| Cl(1)—N(1) | 1.77 | (2) |
| Cl(1)—N(1)#11 | 1.77 | (2) |
| N(1)—C(1) | 1.74 | (11) |
| C(1)—C(1)#12 | 1.42 | (5) |
| O(2)—Zr(1)—O(2)#1 | 70.7 | (6) |
| O(2)—Zr(1)—O(2)#2 | 70.7 | (6) |
| O(2)#1—Zr(1)—O(2)#2 | 109.7 | (12) |
| O(2)—Zr(1)—O(2)#3 | 109.7 | (12) |
| O(2)#1—Zr(1)—O(2)#3 | 70.7 | (6) |
| O(2)#2—Zr(1)—O(2)#3 | 70.7 | (6) |
| O(2)—Zr(1)—O(1) | 142.50 | (13) |
| O(2)#1—Zr(1)—O(1) | 78.8 | (5) |
| O(2)#2—Zr(1)—O(1) | 142.50 | (13) |
| O(2)#3—Zr(1)—O(1) | 78.8 | (5) |
| O(2)—Zr(1)—O(1)#4 | 142.50 | (13) |
| O(2)#1—Zr(1)—O(1)#4 | 142.50 | (13) |
| O(2)#2—Zr(1)—O(1)#4 | 78.8 | (5) |
| O(2)#3—Zr(1)—O(1)#4 | 78.8 | (5) |
| O(1)—Zr(1)—O(1)#4 | 74.3 | (3) |
| O(2)—Zr(1)—O(1)#5 | 78.8 | (5) |
| O(2)#1—Zr(1)—O(1)#5 | 78.8 | (5) |
| O(2)#2—Zr(1)—O(1)#5 | 142.50 | (13) |
| O(2)#3—Zr(1)—O(1)#5 | 142.50 | (13) |
| O(1)—Zr(1)—O(1)#5 | 74.3 | (3) |
| O(1)#4—Zr(1)—O(1)#5 | 117.2 | (7) |
| O(2)—Zr(1)—O(1)#3 | 78.8 | (5) |
| O(2)#1—Zr(1)—O(1)#3 | 142.50 | (13) |
| O(2)#2—Zr(1)—O(1)#3 | 78.8 | (5) |
| O(2)#3—Zr(1)—O(1)#3 | 142.50 | (13) |
| O(1)—Zr(1)—O(1)#3 | 117.2 | (7) |
| O(1)#4—Zr(1)—O(1)#3 | 74.3 | (3) |
| O(1)#5—Zr(1)—O(1)#3 | 74.3 | (3) |
| O(2)—Zr(1)—Zr(1)#6 | 35.3 | (3) |
| O(2)#1—Zr(1)—Zr(1)#6 | 35.3 | (3) |
| O(2)#2—Zr(1)—Zr(1)#6 | 90.1 | (5) |
| O(2)#3—Zr(1)—Zr(1)#6 | 90.1 | (5) |
| O(1)—Zr(1)—Zr(1)#6 | 111.6 | (2) |
| O(1)#4—Zr(1)—Zr(1)#6 | 166.4 | (3) |
| O(1)#5—Zr(1)—Zr(1)#6 | 76.4 | (3) |
| O(1)#3—Zr(1)—Zr(1)#6 | 111.6 | (2) |
| O(2)—Zr(1)—Zr(1)#7 | 35.3 | (3) |
| O(2)#1—Zr(1)—Zr(1)#7 | 90.1 | (5) |
| O(2)#2—Zr(1)—Zr(1)#7 | 35.3 | (3) |
| O(2)#3—Zr(1)—Zr(1)#7 | 90.1 | (5) |
| O(1)—Zr(1)—Zr(1)#7 | 166.4 | (3) |
| O(1)#4—Zr(1)—Zr(1)#7 | 111.6 | (2) |
| O(1)#5—Zr(1)—Zr(1)#7 | 111.6 | (2) |
| O(1)#3—Zr(1)—Zr(1)#7 | 76.4 | (3) |
| Zr(1)#6—Zr(1)—Zr(1)#7 | 60 | |
| O(2)—Zr(1)—Zr(1)#8 | 90.1 | (5) |
| O(2)#1—Zr(1)—Zr(1)#8 | 90.1 | (5) |
| O(2)#2—Zr(1)—Zr(1)#8 | 35.3 | (3) |
| O(2)#3—Zr(1)—Zr(1)#8 | 35.3 | (3) |
| O(1)—Zr(1)—Zr(1)#8 | 111.6 | (2) |
| O(1)#4—Zr(1)—Zr(1)#8 | 76.4 | (3) |
| O(1)#5—Zr(1)—Zr(1)#8 | 166.4 | (3) |
| O(1)#3—Zr(1)—Zr(1)#8 | 111.6 | (2) |
| Zr(1)#6—Zr(1)—Zr(1)#8 | 90 | |
| Zr(1)#7—Zr(1)—Zr(1)#8 | 60 | |
| O(2)—Zr(1)—Zr(1)#9 | 90.1 | (5) |
| O(2)#1—Zr(1)—Zr(1)#9 | 35.3 | (3) |
| O(2)#2—Zr(1)—Zr(1)#9 | 90.1 | (5) |

### Synthesis of UiO-66-NH₂ Coating on Fiber

Forty pieces of PET textile (5 cm×5 cm), 2-aminobenzene-1,4-dicarboxylic acid (BDC-NH₂) (45 mmol, 8.1 g) and ZrOCl₂·8H₂O (30 mmol, 9.7 g) were mixed in DI water (200 mL) and trifluoroacetic acid (TFA) (100 mL) in a sealed 1 L Pyrex Schott bottle. After sonication for 0.5 h, the mixture was placed in an oven at 100° C. for 6 h. After cooling down, the composite samples were washed by deionized water (2×50 mL) and acetone (3×50 mL). Finally, the samples were dried at room temperature and activated at 110° C. for 24 h under dynamic vacuum. Caution! All research with TFA must be conducted in a well-ventilated chemical fume hood with adequate personal protective equipment (at minimum a properly fitting lab coat, long pants and closed-toed footwear, and chemical safety glasses must be worn).

### Scaled-Up Synthesis of UiO-66-NH₂ Coating on Fiber

Two pieces of PET textile (20 cm×20 cm), 2-aminobenzene-1,4-dicarboxylic acid (BDC-NH₂) (90 mmol, 16.2 g) and ZrOCl₂·8H₂O (60 mmol, 19.4 g) were mixed in DI water (400 mL) and TFA (200 mL) in a sealed 1 L Pyrex Schott bottle. After sonication for 0.5 h, the mixture was placed in an oven at 100° C. for 6 h. After cooling down to room temperature, the obtained fabric samples were washed by DI water (2×500 mL), acetone (3×500 mL). Finally, the samples were dried at room temperature, and activated at 110° C. for 24 h under dynamic vacuum. Caution! All research with TFA must be conducted in a well-ventilated chemical fume hood with adequate personal protective equipment (at minimum a properly fitting lab coat, long pants and closed-toed footwear, and chemical safety glasses must be worn).

### Synthesis of MOF-808 Coating on Fiber

Four pieces of washed PET textile (5 cm×5 cm) were added into a mixture of 0.42 g benzene-1,3,5-tricarboxylic acid (BTC) (2 mmol) and 1.45 g ZrOCl₂·8H₂O (4.5 mmol), 20 mL DI water and 20 mL TFA in an 80 mL Pyrex Schott bottle. After sonication for 0.5 h, the sealed bottle was placed in an oven at 100° C. for 5 h. After cooling down to room temperature, the obtained composites were washed with DI water (2×50 mL) and acetone (3×50 mL). Finally, the samples were dried at room temperature, and activated at 110° C. for 24 h under dynamic vacuum. Caution! All research with TFA must be conducted in a well-ventilated chemical fume hood with adequate personal protective equipment (at minimum a properly fitting lab coat, long pants and closed-toed footwear, and chemical safety glasses must be worn).

### Mass Loading Determination

Mass loadings of Zr-MOFs on fiber were calculated based on ICP-OES analysis. All fibrous samples were dried in a vacuum oven overnight at 100° C. prior to ICP-OES analysis. Following that, 20 mg of sample was quickly weighed and digested in 2 mL HNO₃. 100 μL of the digested solution was then diluted into 10 mL using Milli-Q water to measure the Zr concentration using ICP-OES method. The mass loading (ML) is calculated using the following equation:

$$ML = ( C \times 100 \times 0.01 L ) / ( 100 mg \times {W}_{Zr} ) \times 100 \%$$

where C is the concentration of Zr in the diluted nitric acid solution measured by ICP-OES in mg/L. The dilution factor is 100 and the volume of digested solution used is 0.01 L. W_{Zr} is the mass percentage in MOFs: 35.3% for MOF-808 and 32.8% for UiO-66-NH₂. The mass loading of UiO-66-NH₂ and MOF-808 on PET is 23% and 26%, respectively, calculated from ICP-OES analysis.

### Chlorination and Chlorine Determination

2% Clorox bleaching solution (adjusting pH to 5 using 10% H₂SO₄) or 1% sodium dichloroisocyanurate water solution (used without adjusting pH) was used in chlorination of UiO-66-NH₂/PET. One piece of UiO-66-NH₂/PET was immersed in 0.5 L bleach solution at room temperature at predetermined concentrations. The chlorinated cloth sample was washed using DI water to remove unreacted chlorine, and then washed using acetone and dried in a hood overnight. The active chlorine loading on the composite was quantitatively determined by a modified iodometric/thiosulfate titration method. One piece of UiO-66-NH₂/PET (1 cm×1 cm) was added into 3 mL of a mixture of ethanol and 0.1 N acetic acid (9:1 v/v), and 0.2 g KI was added in the above mixture. The iodide ions were oxidized by active chloramine (N—Cl) to the release of iodine, which was then titrated with thiosulfate (0.01 N) until the yellow color disappeared at the end point.

Below are the reactions during the titration process:

N—Cl+2I⁻+H⁺→N—H+I₂+Cl⁻

I₂+2S₂O₃²⁻→2I⁻+S₄O₆²⁻

The chlorine loading (Cl %) is calculated according to

$$Cl \% = ( N * V * 35.45 * 100 ) / ( W * 2 )$$

where N and V are the normality (equiv/L) and used volume (L) of the titrant sodium thiosulfate solution, respectively, and W is the weight (g) of the fiber samples.

### UiO-66-NH—Cl Single Crystal Synthesis

In a 20-mL scintillation vial, BDC-NH₂ (3.1 mg, 0.017 mmol), zirconyl chloride octahydrate (6.3 mg, 0.019 mmol), DMF (1 mL), and formic acid (1.25 mL) were added, and the vial was sonicated until complete dissolution. The vial was then heated at 130° C. for 4 days to yield crystals. After DMF washing for three times, the single crystal was chlorinated in 1% NaDCC water solution for 24 h for single-crystal X-ray diffraction.

### Antibacterial Efficacy Tests

A modified AATCC (American Association of Textile Chemists and Colorists) 100-2004 test method was used to evaluate the antibacterial efficacies of the chlorinated MOF-coated surface. For safety purposes, commercially available low pathogenic Gram-positive Staphylococcus aureus 6538, and Gram-negative Escherichia coli 43895 bacteria were used in biocidal efficacy. The pre-cultured bacterial microorganisms were diluted into 107-108 colony-forming units (CFU)/mL and suspended in a physiological saline solution with 0.2% non-ionic surfactant Tween 20 to enhance wetting of cloth. 100 μL of microorganism suspension was placed onto the center of the fiber (5 cm×5 cm), then the textile was “sandwiched” using another identical sample to ensure full contact. To quench the chlorine, after different periods of contact time, the samples were transferred into 50 ml of sterilized sodium thiosulfate (Na₂S₂O₃) aqueous solution (0.05 wt. %). The mixtures were vigorously vortexed for 1 min and sonicated for 5 min to neutralize the active chlorine and detach adherent cells from the fabric surfaces. The resultant solutions were serially diluted, and 100 μl of bacteria diluent was placed onto the agar. The viable microbial colonies for bacteria on agar plates were visually counted after incubation at 37° C. for 24 h for biocidal efficacy analysis.

### SEM Analysis of Bacterial Cell

The bacteria harvested from the control or chlorinated samples by vortex were washed three times with Phosphate-buffered Saline pH 7.4 (PBS). The bacterial samples were fixed in 2 wt. % of glutaraldehyde in PBS solution at 4° C. overnight and rinsed with DI water three times. Bacterial samples were then dehydrated in a sequential mixture of acetone/water with acetone content of 30, 50, 70, 90, and 100% for 1 h, respectively. The obtained bacterial cells were carefully casted onto a piece of aluminum foil. A 10-nm gold layer was coated onto bacterial cells for SEM observation.

### Anti-SARS-CoV-2 Virus Test

Vero African green monkey kidney epithelial cells were obtained from ATCC® and SARS-CoV-2 (strain/NL/2020) was obtained from the European Virus Archive (Marseille, France). All work involving live SARS-CoV-2 was conducted in Biosafety Lab Level 3 (BSL-3). Vero cells were grown onto T25 flasks (Corning) in a 5% CO₂ incubator at 37° C. with Dulbecco's Modified Eagle Medium supplemented with 5% heat-inactivated fetal bovine serum, 1% Penicillin and Streptomycin. At 70-80% confluency, cells were inoculated with viral particles which had been pre-incubated with MOF-cloth or control cloth. In brief, pre-cultured virus was diluted to 109 viral particles/mL in culture medium. 100 μL of this virus suspension was placed onto the center of the cloth (2.5 cm×2.5 cm). After 15 minutes of contact time, the MOF coated fiber sample was transferred to 1 mL of 3 mM sodium thiosulfate (Na₂S₂O₃) solution. The mixtures were vigorously vortexed for 2 minutes to detach any adherent viral particles from the fabric surfaces. The resultant solutions were transferred (300 μL) to Vero cell culture grown at 70-80% confluency. At indicated time points, cell-culture medium was collected and checked for virus growth and images were taken using a digital cell imaging system (Evos XL core).

### SARS-CoV-2 RT-PCR

SARS-CoV-2 (strain/NL/2020) RNA was converted into complementary DNA (cDNA) and amplified using Super Script™ III One-Step RT-PCR System with Platinum™ Taq DNA Polymerase kit (catalog 12574018, Thermo fisher, USA). 10 microliters of culture supernatant (heat activated 1 h 70° C.) was used and thermal cycling was performed at 55° C. for 10 min for reverse transcription, followed by 95° C. for 3 min and then 45 cycles of 95° C. for 15 s, 58° C. for 30 s. Specific primers for the N-gene used are according to guidelines from the Center for Disease Control and Prevention (Atlanta, USA). Information regarding the Forward and Reverse Primers can be found in the Supporting Information (SI) for Cheung, Yuk Ha, et al. “Immobilized regenerable active chlorine within a zirconium-based MOF textile composite to eliminate biological and chemical threats.” Journal of the American Chemical Society 143.40 (2021): 16777-16785.

### Durability and Cyclability

The durability was evaluated after storage at ambient conditions (25° C. and 65% relative humidity) for 40 days, followed by determining the remaining chlorine using the procedure mentioned above. To test the leach of active chlorine from composite to water, 1 g composite with 1.88% active chlorine was immersed in 20 mL Saline water (0.9% NaCl) for 48 hours. After removing the composite, 0.5 g of potassium iodide was added. After stirring the sealed vial under nitrogen atmosphere for 30 min, the chlorine concentration was titrated with 0.001 N Na₂S₂O₃ solution. To test the cyclability, chlorinated fabrics were quenched in 0.1 wt. % of Na₂S₂O₃ aqueous solution to remove the active chlorine, and then rechlorinated with 1% bleaching solution. The recovered chlorine was determined using the titration method described above.

### CEES Oxidation

CEES oxidation experiments on fiber composite were carried out at room temperature. 27 μmol CEES (3 μL) was then carefully added onto the center of the UiO-66-NH—Cl/PET composite (1 cm×5 cm, chlorine loading 1.88%) containing 82.4 μmol active chlorine to get a molar ratio of 1/3 for CEES/chlorine, and then the chamber was put at 50% humidity for recorded time. To prepare the sample for NMR analysis, 1 mL of CD₃OH/D20 (80/20 V/V) containing 50 mg sodium thiosulfate was added into the incubated vial. The vial was sealed, vortexed for 1 min, and then transferred to an NMR tube for measurement.

### HD Oxidation

HD oxidation experiments on fiber composite were carried out at room temperature. 27 μmol HD (3.4 μL) was then carefully added onto the center of the UiO-66-NH—Cl/PET composite (1 cm×5 cm, chlorine loading 1.88%) containing 82.4 μmol active chlorine to get a molar ratio of 1/3 for HD/chlorine, and then the chamber was put at 50% humidity for recorded time. To prepare the samples for NMR analysis, 1 mL of CD₃OH/D20 (80/20 V/V) containing 50 mg sodium thiosulfate was added into the incubated vial. The vial was sealed, vortexed for 1 min, and then transferred to an NMR tube for measurement. Caution! HD should only be used in approved labs by specifically trained personnel.

It can be clearly observed that the fluorine at ˜690.5 eV was absent after chlorination, indicating the removal of modulator from MOF Zr₆ node. A significant peak belonging to the chloride appeared at ˜200 eV after Cl chlorination, indicating the successful introduction of chloride onto the UiO-66-NH₂. Further study on the high-resolution Cl 2p spectrum witnessed a spin-orbit-split doublet of Cl 2p_{3/2} (BE at 199.8 eV) and Cl 2p_{1/2} (BE of at 201.3 eV) which can then be strongly related to the presence of the N-chlorine species. The generation of a wide peak with BE at 196.4 eV might be due to the formation of chloride radical during the X-ray excitation in the XPS analysis chamber.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A functionalized metal-organic framework comprising:
a metal-organic framework comprising metal nodes and organic linkers connecting the metal nodes; and
chloramine functional groups on the organic linkers.

2. The functionalized metal-organic framework of claim 1, wherein the organic linkers are 1,4-benzene-dicarboxylate linkers.

3. The functionalized metal-organic framework of claim 1, wherein the metal nodes are zirconium nodes.

4. The functionalized metal-organic framework of claim 3, wherein the organic linkers are 1,4-benzene-dicarboxylate linkers.

5. The functionalized metal-organic framework of claim 1, wherein the metal-organic framework is a UiO-66 metal-organic framework having the chloramine functional groups in its organic linkers.

6. The functionalized metal-organic framework of claim 5, wherein at least 20% of the organic linkers have a chloramine functional group.

7. The functionalized metal-organic framework of claim 1, wherein at least 20% of the organic linkers have a chloramine functional group.

8. A textile comprising:
fibers; and
functionalized metal-organic frameworks on the fibers, the functionalized metal-organic frameworks comprising:
a metal-organic framework comprising metal nodes and organic linkers connecting the metal nodes; and
chloramine functional groups on the organic linkers.

9. The textile of claim 8, wherein the fibers are woven fibers.

10. The textile of claim 8, having a chlorine loading of at least 0.05 wt. %.

11. The textile of claim 8, having a chlorine loading in the range from 0.05 wt. % to 5 wt. %.

12. The textile of claim 8, wherein the organic linkers are 1,4-benzene-dicarboxylate linkers.

13. The textile of claim 8, wherein the metal nodes are zirconium nodes.

14. The textile of claim 13, wherein the organic linkers are 1,4-benzene-dicarboxylate linkers.

15. The textile of claim 8, wherein the metal-organic framework is a UiO-66 MOF having the chloramine functional groups in its organic linkers.

16. The textile of claim 1, wherein at least 20% of the organic linkers have a chloramine functional group.

17. A wearable face mask comprising:
a panel comprising a textile, the textile comprising:
fibers; and
functionalized metal-organic frameworks on the fibers, the functionalized metal-organic frameworks comprising:
a metal-organic framework comprising metal nodes and organic linkers connecting the metal nodes; and
chloramine functional groups on the organic linkers:
a first strap connected to a first end of the panel; and
a second strap connected to a second end of the panel,
wherein the first and second panels are configured to wrap around the ears or head of a human user to keep the panel over the nose and mouth of the human user.

18. A method of deactivating a pathogen or organic molecule, the method comprising exposing a chloramine-functionalized metal-organic framework to an environment comprising the pathogen or the organic molecule and water, whereby hypochlorite is generated and reacts with and deactivates the pathogen or organic molecule.

19. The method of claim 18, wherein the environment comprises the pathogen and the pathogen is a SARS-CoV-2 virus.

20. The method of claim 18, wherein the metal-organic framework is a UiO-66 metal-organic framework having the chloramine functional groups on its organic linkers.
